(19) United States
(12) Patent Application Publication
(10) Pub. No.: US 2026/0257589 A1
(43) Pub. Date: Sep. 3, 2026

(54) VEHICLE SEAT WITH ELECTRIC SEAT DEPTH AND SEAT INCLINATION ADJUSTMENT

(71) Applicant: GRAMMER Aktiengesellschaft, Ursensollen (DE)

(72) Inventors: Michael BÖHMER, Waldgrehweiler (DE); Konstantin LOREY, Schmidgaden (DE); Alexander LOREY, Maxhütte-Haidhof (DE); Sergej SCHUSTJEW, Sulzbach-Rosenberg (DE)

(21) Appl. No.: 19/551,960

(22) Filed: Feb. 27, 2026

(30) Foreign Application Priority Data
Mar. 3, 2025 (DE) 102025107945.5

(51) Int. Cl. B60N 2/02; B60N 2/10; B60N 2/16; B60N 2/64

(52) U.S. Cl. CPC B60N 2/02253; B60N 2/10; B60N 2/16; B60N 2/646

(57) ABSTRACT

The invention relates to a vehicle seat (1) comprising a vehicle seat substructure (2) having a lower portion (3) and an upper portion (4) that is height-adjustable relative thereto, and a seat assembly (5) fastened to the upper portion (4). The seat assembly (5) comprises an at least partially shell-shaped seat carrier (6), a seat depth plate (7) for adjusting a seat depth, and a seat inclination plate (8) for adjusting a seat inclination. The seat depth plate (7) is arranged displaceable in a longitudinal direction (X) within the seat carrier (6), and the seat inclination plate (8) is arranged rotatable about a first rotation axis (A) extending in the transverse direction (Y) and located above the seat depth plate (7). The vehicle seat (1) further comprises a first electric drive unit (9) for adjusting the seat depth, the first electric drive unit (9) being arranged in a vertical direction (Z) between the seat depth plate (7) and the seat inclination plate (8).

### CROSS-REFERENCE TO RELATED APPLICATIONS

This application claims priority to German Patent Application 102025107945.5 filed on Mar. 3, 2025, the contents of which are incorporated by reference herein in their entirety.

### BACKGROUND

The invention relates to a vehicle seat comprising a vehicle seat substructure having a lower portion and an upper portion that is height-adjustable relative thereto, and a seat assembly fastened to the upper portion, wherein the seat assembly comprises an at least partially shell-shaped seat carrier, a seat depth plate for adjusting a seat depth, and a seat inclination plate for adjusting a seat inclination, wherein the seat depth plate is arranged displaceable in a longitudinal direction in the seat carrier, and the seat inclination plate is arranged above the seat depth plate so as to be rotatable about a rotation axis extending in the transverse direction.

Utility vehicles, such as agricultural machines, construction machines or transport vehicles, are typically used for extended continuous periods, such that seating comfort for an occupant plays a paramount role. Corresponding vehicle seats are therefore equipped with a variety of comfort features, for example electric adjustment systems.

In existing vehicle seats, the electric adjustment systems are limited to setting the seat height, the distance to a steering wheel, or the inclination of the backrest. An electric adjustment of the seat inclination or of the seat depth has not previously been provided, or can only be implemented with disadvantages. In contrast to passenger cars, in which there is ample space under the seat for arranging electric drives, the installation space in utility vehicles is severely limited. In particular, vehicle seats in utility vehicles frequently comprise additional spring systems that significantly contribute to the overall height of the seat.

Due to the limited cab height of utility vehicles, seat components are correspondingly arranged directly on the spring systems or on adjustment rails fastened to the spring systems. To arrange electric adjustment systems, it then becomes necessary to create additional installation space, for example by a thicker seat cushion or an additional distance between the seat carrier and the adjustment rail, in order to be able to accommodate components such as an electric motor.

### SUMMARY

Consequently, it is an object of the invention to provide a vehicle seat in which, with the same installation space as for purely mechanical seats and without a reduction of the cushion thickness or an increase of the seat index point, fully electric adjustment of at least the seat depth and preferably also the seat inclination is possible.

To achieve the object, a vehicle seat is provided comprising a vehicle seat substructure having a lower portion and an upper portion that is height-adjustable relative thereto, and a seat assembly fastened to the upper portion, wherein the seat assembly comprises a seat carrier, a seat depth plate for adjusting a seat depth, and a seat inclination plate for adjusting a seat inclination, wherein the seat depth plate is arranged displaceable in the longitudinal direction in the seat carrier, and the seat inclination plate is arranged above the seat depth plate so as to be rotatable about a first rotation axis extending in the transverse direction, wherein the vehicle seat comprises a first electric drive unit for adjusting the seat depth, the first electric drive unit being arranged in a vertical direction between the seat depth plate and the seat inclination plate.

The object is likewise achieved by a vehicle seat comprising an at least partially shell-shaped seat carrier, a seat depth plate for adjusting a seat depth, and a seat inclination plate for adjusting a seat inclination, wherein the seat depth plate is arranged displaceable in the longitudinal direction in the seat carrier, and the seat inclination plate is arranged above the seat depth plate so as to be rotatable about a first rotation axis extending in the transverse direction, wherein the vehicle seat comprises a first electric drive unit for adjusting the seat depth, the first electric drive unit being arranged in the vertical direction between the seat depth plate and the seat inclination plate. Accordingly, all features of a vehicle seat with a vehicle seat substructure, where applicable, are intended to apply also to a vehicle seat without a vehicle seat substructure.

In the following, the longitudinal direction, transverse direction, and vertical direction are oriented according to the customary orientation of a vehicle seat, in which a seat surface extends essentially along the longitudinal and transverse directions, and a backrest extends essentially along the transverse and vertical directions. Positional indications such as above, below, front, rear, etc., are made from the perspective of an occupant of the vehicle seat.

The vehicle seat usually comprises a vehicle seat substructure that is screwed to a vehicle body and a seat assembly arranged above it. The substructure consists of a scissor frame that connects a lower portion to an upper portion in a height-adjustable manner. In addition, a spring element and/or a damping element is provided, which springs and/or damps movement between the upper and lower portions. The seat assembly comprises at least a seat carrier that extends essentially in the longitudinal and transverse directions and preferably a back carrier that extends essentially in the transverse and vertical directions. The back carrier is usually arranged on the seat carrier so as to be rotatable about the transverse direction, such that an angle between the seat carrier and the back carrier is variable.

According to one embodiment, the seat carrier is formed at least partially, preferably entirely, as a seat carrier shell and is preferably fixed to the upper portion or to an adjustment rail by which the entire seat assembly can be displaced relative to the vehicle seat substructure in the longitudinal direction. Alternatively, the seat carrier can also be formed as a frame structure. Preferably, a seat depth plate is arranged in or on the seat carrier and displaceable relative thereto, by which the depth of a seat surface can be varied. Furthermore, a seat inclination plate is preferably also arranged in or on the seat carrier, by which an inclination of the seat surface relative to the main extent of the seat carrier can be varied. According to the invention, the first electric drive unit for adjusting the seat depth is arranged between the seat depth plate and the seat inclination plate. Accordingly, neither above the seat inclination plate nor below the seat depth plate must additional installation space be provided for arranging the drive unit.

In a particularly preferred embodiment, the seat depth plate and the seat inclination plate are arranged at least partially overlapping and form an overlap region, wherein the first drive unit is arranged in the overlap region between the seat depth plate and the seat inclination plate.

Preferably, the two plates overlap at least partially in a rear region of the seat inclination plate facing the vehicle seat and in a front region of the seat depth plate facing away from the vehicle seat. Owing to the overlap between the two plates, a substantially continuous support surface for a seat cushion can advantageously be produced. As a result, it is possible to dispense with providing a recess in the seat cushion for receiving the drive unit. It is furthermore advantageous that the seat cushion can be designed with a uniform or continuous cushion thickness, whereby seating comfort can be increased.

In a particularly preferred embodiment, the vehicle seat comprises a second electric drive unit for adjusting the seat inclination, wherein the second electric drive unit is arranged substantially laterally next to the seat depth plate and between the seat carrier and the seat inclination plate.

Advantageously, the second electric drive unit is also arranged below the seat inclination plate and above the seat carrier. Thus, it is possible to dispense with a recess in the seat cushion for receiving the second drive unit, such that the seat cushion can be formed uniformly and continuously. The seat cushion is therefore in particular free of recesses for receiving drive units for adjusting the seat depth and/or seat inclination. According to one embodiment, the drive unit is arranged at least partially in front of the seat depth plate and at least partially next to the seat depth plate.

In a particularly preferred embodiment, the vehicle seat comprises a guide device that connects the seat depth plate displaceably to the seat carrier, the guide device comprising a sliding-block-in-groove guidance.

The guide device preferably connects the seat depth plate and the seat carrier in a form-fitting manner. In particular, the form fit permits only a displacement of the seat depth plate in the longitudinal direction, whereas movement in the transverse direction and in the vertical direction is essentially blocked.

According to a preferred embodiment, the seat depth plate has at least two, preferably four grooves extending in the longitudinal direction. The grooves can be formed as recesses in or as through-passages through the seat depth plate. The seat carrier has complementary sliding blocks which are arranged to slide in the grooves. Alternatively, the grooves can also be arranged in or on the seat carrier and the sliding blocks on the seat depth plate.

The grooves can furthermore have a removal opening, through which the sliding blocks can be removed from the grooves or inserted into the grooves. In particular, the removal openings are arranged in a rear region of the grooves, wherein the seat plate part can be removed from the seat carrier or inserted into the seat carrier in a position with maximum seat depth.

In a particularly preferred embodiment, the first electric drive unit comprises a first electric motor, a first spindle operatively connected thereto, and a first travelling nut arranged on the first spindle, wherein the first drive unit is fastened to the seat depth plate and the first travelling nut is received in a rotation-secured manner in a first receiving element which is fastened to the seat carrier.

According to a preferred embodiment, the first electric motor has a motor diameter of less than 50 mm, more preferably less than 40 mm, and particularly preferably less than or equal to 30 mm. The first motor and the first spindle are preferably arranged fixedly on the seat depth plate on a plastics holder. The travelling nut is secured against rotation by the first receiving element on the seat carrier such that a rotary movement of the spindle causes a linear movement of the seat depth plate relative to the seat carrier. The linear movement enabled by the rotation of the spindle is preferably greater than 40 mm, more preferably greater than 50 mm, and particularly preferably greater than or equal to 60 mm. A seat depth of the vehicle seat can therefore be set between a minimal position with a minimal seat depth and a maximal position with a maximally usable seat depth. In addition to the maximal position, an assembly position is also provided for insertion and removal of the seat depth plate into and from the seat carrier. In one embodiment, the assembly position corresponds to a linear movement or displacement of 75 mm or more. In this position, the thread engagement between the spindle and the nut can be established or released and thereby the operative connection between the first electric motor and the seat carrier can be established or released. Before or after releasing the thread engagement between the and the nut, the seat plate can be inserted into the seat carrier or removed from the seat carrier by a movement in the vertical direction. Alternatively, it can also be provided that in the maximal position the travelling nut can be inserted into or removed from the first receiving element.

In a particularly preferred embodiment, the seat inclination plate is connected to the seat depth plate so as to be rotatable about the rotation axis by a floating bearing, the floating bearing being formed by a pin connected to the seat depth plate and a hole-like opening in the seat inclination plate.

Advantageously, the floating permits a limited movement of the seat inclination plate relative to the seat depth plate in the vertical and longitudinal directions. The hole-like opening is substantially larger than the pin. Preferably, the seat inclination plate is connected to the seat depth plate via a right and a left floating bearing. The floating bearings are preferably arranged at a rear end of the seat inclination plate. Alternatively, the pins can also be arranged on the seat depth plate and the openings on the seat inclination plate.

In a particularly preferred embodiment, the second electric drive unit comprises a second electric motor, a second spindle operatively connected thereto, and a second travelling nut arranged on the second spindle, wherein the second drive unit is fastened to the seat depth plate and the second travelling nut is received in a rotation-secured manner in a second receiving element, wherein the second receiving element is designed in the manner of a lever and is connected to the seat depth plate so as to be rotatable about a second rotation axis, wherein a first lever arm receives the second travelling nut and a second lever arm is connected to the seat inclination plate.

Particularly preferably, at a front end of the seat depth plate a, in particular cylindrical, cross bar is fastened so as to be rotatable about the transverse direction. Preferably, the cross bar is connected to the seat depth plate by a bracket-like spacer extending perpendicular to the transverse direction. Furthermore, the vehicle seat preferably comprises a right and a left spacer. The seat inclination plate is connected to the cross bar, wherein a rotary movement of the cross bar leads to a change in the inclination of the seat inclination plate relative to the seat carrier. According to one embodiment, one of the two spacers is formed as the second lever arm of the second receiving element. The second receiving element is formed with an angular shape, wherein the first lever arm is connected to the second travelling nut such that a linear movement of the travelling nut is converted into a rotary movement of the second receiving element about the transverse direction. The second lever arm is connected to the cross such that the rotary movement of the receiving element results in a rotary movement of the cross bar. The second electric motor and the second spindle are in particular mounted rotatably on the seat depth plate, and in particular at least partially laterally next to the seat depth plate. The seat depth plate can be formed at least partially trapezoidal, wherein it has a smaller width in a front region than in a rear region. According to one embodiment, the spindle is arranged at least partially laterally next to the seat depth plate and the second electric motor completely in front of the seat depth plate.

In a particularly preferred embodiment, the seat depth plate and the seat inclination plate, together with the first drive unit and the second drive unit, are designed as a seat subassembly that can be inserted into the seat carrier as a unit, wherein the seat subassembly comprises a seat cushion, and wherein at least the seat inclination plate is arranged between the drive units and the seat cushion.

Forming the seat depth plate and the seat inclination plate as a seat subassembly allows in particular easy maintainability of the vehicle seat by exchange as a unit. The drive units are accessible without removing the seat carrier, which is advantageous over conventional vehicle seats in which the drive units are arranged below the seat carrier. Furthermore, owing to the fact that the drive units are arranged at least between the seat inclination plate and the seat carrier, a seat cushion can be manufactured without drive-unit-induced recesses. Accordingly, the drive units are pre-assembled in the cushioned seat subassembly and are provided, together with the seat inclination plate and the seat depth plate, for joint installation or removal as the seat subassembly.

In a particularly preferred embodiment, the first electric motor and the second electric motor extend essentially along the transverse direction, and the first spindle and the second spindle extend essentially along the longitudinal direction.

Advantageously, the electric motors can be arranged in the transverse direction, whereas the spindles can be arranged in the longitudinal direction. In this way, a largest possible stroke for the drive units can be realized in a small installation space.

### DRAWINGS

Further advantageous embodiments are apparent from the dependent claims and the following description in connection with the drawings. The drawings show:

FIG. 1 a general view of a vehicle seat;

FIG. 2 a side view of a seat assembly;

FIG. 3 a plan view of a seat assembly with seat inclination plate;

FIG. 4 a plan view of a seat assembly without seat inclination plate;

FIG. 5a a sectional view of a seat assembly with minimal seat depth;

FIG. 5b a sectional view of a seat assembly with maximal seat depth;

FIG. 6a a sectional view of a seat assembly with minimal seat inclination;

FIG. 6b a sectional view of a seat assembly with maximal seat inclination.

In the figures, certain reference signs have been omitted for clarity.

### DESCRIPTION

FIG. 1 shows a vehicle seat (1) according to the invention in a side view. The vehicle seat (1) can be divided along the vertical direction (Z) into a seat assembly (5) located above and a vehicle seat substructure (2) located below. The vehicle seat (1) comprises a lower portion (3), which is fastened to the vehicle body, and an upper portion (4), to which the seat assembly (5) is fastened. The lower portion (3) and the upper portion (4) are connected to each other so as to be height-adjustable and sprung by means of a scissor frame not shown here. The upper portion (4) additionally comprises a pair of adjustment rails (4a) in order to allow displacement of the seat assembly (5) relative to the vehicle seat substructure (2) in the longitudinal direction (X). The seat assembly (5) comprises a seat carrier (6) in which a seat depth plate (7) and a seat inclination plate (8) connected thereto are inserted. The seat depth plate (7) and the seat inclination plate (8) are designed for joint movement relative to the seat carrier (6) in the longitudinal direction (X). A seat cushion (17) is furthermore arranged on the seat depth plate (7) and the seat inclination plate (8). The vehicle seat (1) furthermore comprises a backrest (18) fastened to the seat carrier (6) and a headrest (19) or shoulder support arranged on the backrest (18).

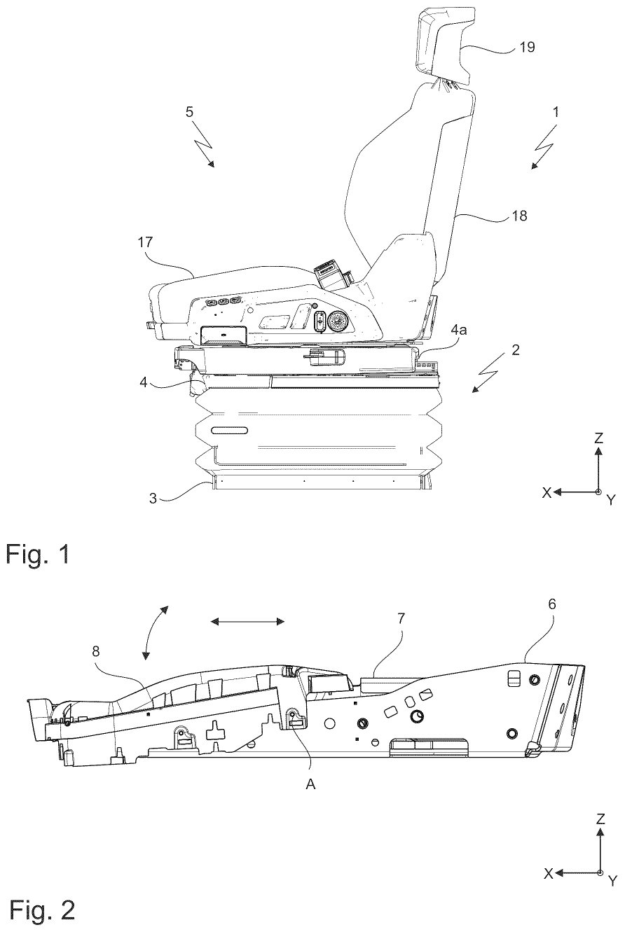

FIG. 2 shows the seat carrier (6) with the seat depth plate (7) and the seat inclination plate (8) in a side view. The seat carrier (6) is formed as a shell, wherein a base is enclosed by a rear wall, a front wall and two side walls. In this way, the seat depth plate (7) with the seat inclination plate (8) can be displaced within the seat carrier (6) along the longitudinal direction (X). The seat depth plate (7) can be inserted into or removed from the seat carrier (6) in the assembly position. For adjustment of a seat inclination, the seat inclination plate (8) is arranged on the seat depth plate (7) so as to be rotatable about the first rotation axis (A). Since the seat depth plate (7) and the seat carrier (6) are arranged essentially parallel, the seat inclination plate (8) is thereby also arranged rotatable relative to the seat carrier (6) about the first rotation axis (A). The seat depth plate (7) is in this case essentially and the seat inclination plate (8) at least partially formed in a shell-shaped manner in order to receive a seat cushion (17) not shown here.

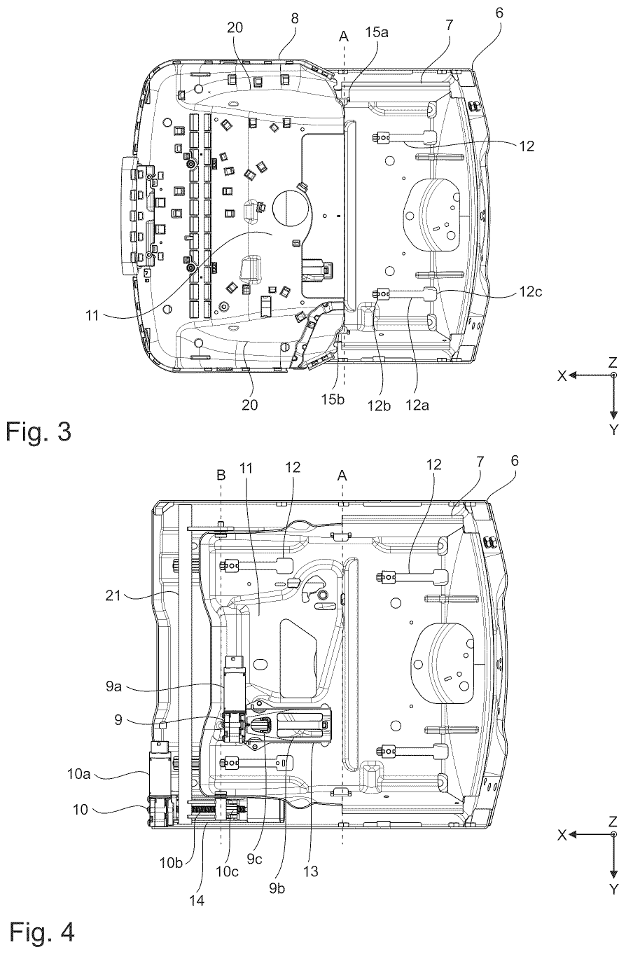

FIG. 3 shows the seat carrier (6), the seat depth plate (7) and the seat inclination plate (8) in a plan view. Viewed in the vertical direction (Z), the seat depth plate (7) is arranged between the seat carrier (6) and the seat inclination plate (8). The seat inclination plate (8) is rotatably connected in a rear region to the seat depth plate (7) via a first floating bearing (15a) and a second floating bearing (15b). Furthermore, the seat depth plate (7) is connected to the seat carrier (6) via guide devices (12) such that the seat depth plate can essentially only move in the longitudinal direction (X). For this purpose, the seat depth plate (7) has four grooves (12a) into which corresponding sliding blocks (12b) of the seat carrier (6) are inserted. The grooves (12a) are arranged in pairs on the right and left sides in a front section and a rear section of the seat depth plate (7). The sliding blocks (12b) can slide in the grooves (12a), enabling movement of the seat depth plate (7) in the longitudinal direction (X). The seat depth plate (7) can thus be moved between an assembly position and a minimal position, wherein the assembly position corresponds to a position in which the seat depth plate (7) is pushed maximally forward relative to the seat carrier (6). In addition, a maximal position of a maximally usable seat depth is provided. The maximal position lies between the minimal position and the assembly position. The minimal position corresponds to a minimal seat depth in which the seat depth plate (7) is pushed maximally rearward. At a rear end, the grooves (12a) have a removal opening (12c). The removal opening (12c) is formed larger than the sliding blocks (12b) such that the seat depth plate (7) can be removed upward from the seat carrier (6) in the vertical direction (Z). Conversely, the seat depth plate (7) can also be inserted into the seat carrier (6). The seat depth plate (7) can be inserted into or removed from the seat carrier (6) in the assembly position. The seat depth plate (7) and the seat inclination plate (8) also have an overlap region (11) in which the seat depth plate (7) and the seat inclination plate (8) overlap. The overlap region (11) extends in the longitudinal direction (X) essentially from the rotation axis (A) to a front end of the seat depth plate (7). The seat inclination plate (8) furthermore has seat bolsters (20) on the right and left, whereby a seat cushion (17) is supported by the shell-shaped configuration.

FIG. 4 shows a plan view of the seat carrier (6) and the seat depth plate (7). Two grooves (12a) are arranged in the overlap region (11). The first electric drive unit (9) is arranged between the two grooves (12a). The first electric drive unit (9) comprises a first electric motor (9a), which extends essentially in the transverse direction (Y) and is fastened to the seat depth plate (7). The electric motor (9a) drives a first spindle (9b) that extends essentially in the longitudinal direction (X). A first travelling nut (9c) is mounted on the first spindle (9b) and is in thread engagement with the first spindle (9b). Driven by the first electric motor (9a), rotation of the first spindle (9b) moves the first travelling nut (9c) relative to the spindle in the longitudinal direction (X). For this purpose, the first travelling nut (9c) is received in a first receiving element (13) in a rotation-secured manner. The receiving element (13) is fastened to the seat carrier (6), such that by rotation of the first spindle (9b) the seat depth plate (7) can be moved relative to the seat carrier (6) in the longitudinal direction (X). Alternatively, the first receiving element (13) can be fastened to the seat depth plate (7) and the first drive unit (9) to the seat carrier (6). Furthermore, a second drive unit (10) is arranged partially in front of and partially laterally next to the seat depth plate (7). The second drive unit (10) is fastened to the seat depth plate (7) and comprises a second electric motor (10a), a second spindle (10b) and a second travelling nut (10c). The second electric motor (10a) extends essentially along the transverse direction (Y) and the second spindle (10b) extends essentially along the longitudinal direction (X). The second travelling nut (10c) is furthermore received in a second receiving element (14) in a rotation-secured manner. The second receiving element (14) is fastened to the seat depth plate (7) so as to be rotatable about a second rotation axis (B). The second receiving element (14) is rigidly connected to a cross bar (21) extending in the transverse direction (Y), on which the seat inclination plate (8) is mounted. A rotation of the cross bar (21) about the second rotation axis (B) thus causes a rotation of the seat inclination plate (8) about the first rotation axis (A). The receiving element (14) is formed in the manner of a lever such that a movement of the second travelling nut (10c) along the second spindle (10b) causes a rotation of the second receiving element (14) about the second rotation axis (B).

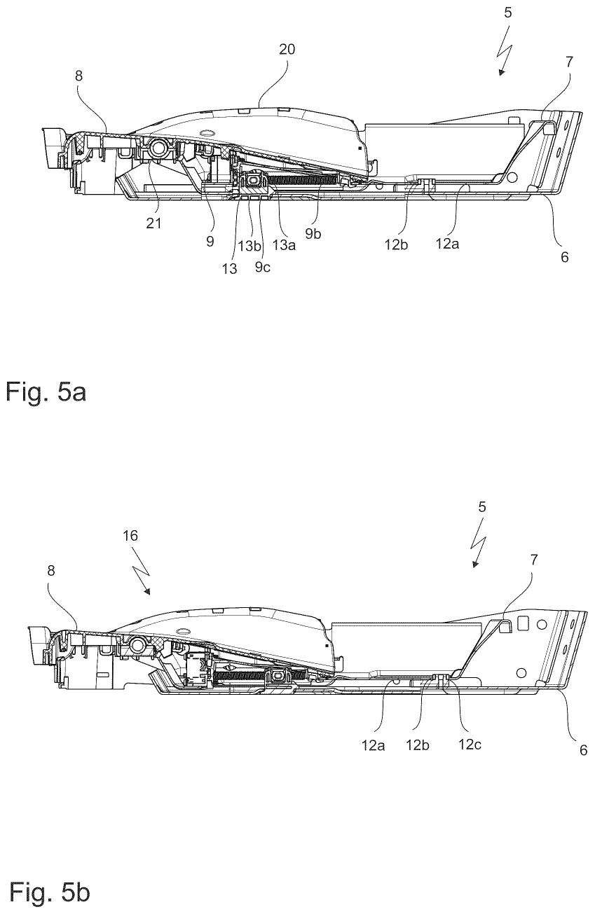

FIG. 5a shows a sectional view of a seat assembly (5) with the seat depth plate (7) in a minimal position. Both the seat carrier (6), the seat depth plate (7) and the seat inclination plate (8) with the seat bolsters (20) are formed at least partially in a shell-shaped manner. In the intermediate space between the seat inclination plate (8) and the seat depth plate (7), the first electric drive unit (9) is arranged such that it is not accessible from outside.

The sliding block (12b) is located in the groove (12a) in a front position. The first travelling nut (9c) is likewise arranged in a front position of the first spindle (9b). The first receiving element (13) is configured in a fork shape and accommodates two pins of the travelling nut (9c) extending in the transverse direction (Y). By means of these pins, the travelling nut (9c) is secured against rotation relative to the longitudinal axis (X). The travelling nut (9c) is arranged at least partially rotatable about the transverse direction (Y) within the fork (13a). The fork (13a) has a substantially rectangular receiving region for receiving the pins of the travelling nut (9c). The pins, in contrast, are formed at least partially round or rounded, in order to facilitate insertion of the pins into the fork (13a). To fix the pins within the fork (13a), one clamping element (13b) is arranged in the fork (13a) for each pin. Each clamping element substantially fills the gap between the fork (13a) and the pin in a complementary manner and fixes the travelling nut (9c) in the fork (13a) of the receiving element (13) by means of an interference fit. Furthermore, the seat inclination plate (8) is mounted on the cross bar (21). The cross bar (21) is received rotatably in a clamp-like receiver of the seat inclination plate (8).

The illustration in FIG. 5b shows a sectional view of a seat assembly (5) with the seat depth plate (7) in an assembly position. The assembly position also corresponds to a removal or insertion position. In this state, the seat subassembly (16) comprising the seat depth plate (7), the seat inclination plate (8), the first electric drive unit (9), the second electric drive unit (10) and the seat cushion (17) can be inserted into the seat carrier (6) as a unit or removed therefrom. The seat subassembly (16) thereby constitutes a pre-assembled module. To insert the seat subassembly (16) into the seat carrier (6), the sliding blocks (12b) are inserted through the removal openings (12c) into the grooves (12a). In addition, the pins of the travelling nut (9c) are inserted into the fork-shaped first receiving element (13). By displacing the seat subassembly (16) relative to the seat carrier (6) in the longitudinal direction (X), the seat subassembly can then be locked to the seat carrier, in that the sliding blocks (12b) are moved at least partially out of the removal openings (12c) along the grooves (12a).

In order to enable removal of the seat subassembly (16) or of the seat depth plate (7) from the seat carrier (6) in the event of a motor malfunction of the first electric drive unit (9) or of the first electric motor (9a), the first receiving element (13) is configured in two parts. A first part is fixed to the seat carrier (6), and a second part, which receives the travelling nut (9c), is detachably connected to the first part by a fastening means. The fastening means is a screw that is accessible from outside the seat carrier (6).

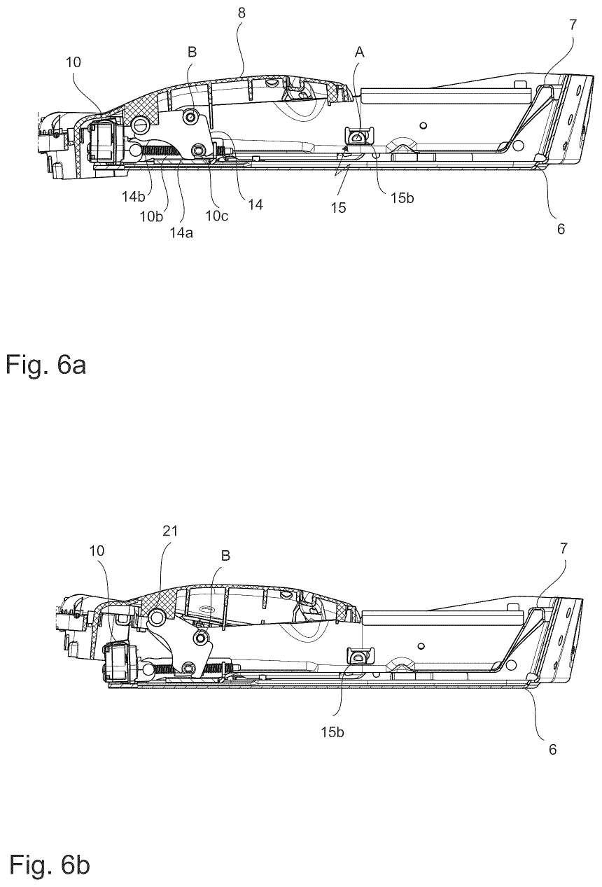

FIGS. 6a and 6b show a sectional view of the seat assembly (5) with the seat inclination plate (8) in a minimally inclined position (FIG. 6a) and in a maximally inclined position (FIG. 6b). In a central region of the seat depth plate (7), the latter has, on the right and left sides in a side wall, a receiving opening in which a pin of the seat inclination plate (8) is mounted in a floating manner. Alternatively, the seat depth plate (7) may carry the pins and the seat inclination plate (8) the receiving openings. The second spindle (10b) is connected in a force-transmitting manner to the second receiving element (14) via the second travelling nut (10c). The second receiving element (14) is an L-shaped lever having a first lever arm (14a) and a second lever arm (14b). The second receiving element (14) is mounted rotatable about the second rotation axis (B) on the seat depth plate (7). While the first lever arm (14a) receives the second travelling nut (10c) in a force-transmitting manner, the second lever arm (14b) is connected to the cross bar (21) that supports the seat inclination plate (8). By displacing the second travelling nut (10c) along the second spindle (10b), the second receiving element (14) and the cross bar (21) are rotatable about the second rotation axis (B), and thereby the seat inclination plate (8) is rotatable about the first rotation axis (A). Both the second electric drive unit (10) and the second receiving element (14) are arranged on the seat depth plate (7). In particular, the second electric motor (10a) is located in front of the seat depth plate (7), and the second spindle (10b), the second travelling nut (10c), and the second receiving element (14) are arranged laterally next to the seat depth plate (7). In the vertical direction (Z), the second drive unit (10) is arranged between the seat inclination plate (8) and the seat carrier (6). According to FIG. 6b, the seat inclination plate (8) is inclined relative to the seat depth plate (7) or to the seat carrier (6). The adjustment of the seat inclination plate (8) is independent of the adjustment of the seat depth plate (7).

### LIST OF REFERENCE SIGNS

1 vehicle seat
2 vehicle seat substructure
3 lower portion
4 upper portion
4a adjustment rails
5 seat assembly
6 seat carrier
7 seat depth plate
8 seat inclination plate
9 first electric drive unit
9a first electric motor
9b first spindle
9c first travelling nut
10 second electric drive unit
10a second electric motor
10b second spindle
10c second travelling nut
11 overlap region
12 guide device
12a groove
12b sliding blocks
12c removal opening
13 first receiving element
13a fork
13b clamping element
14 second receiving element
14a first lever arm
14b second lever arm
15 floating bearing
15a first floating bearing
15b second floating bearing
16 seat subassembly
17 seat cushion
18 backrest
19 headrest
20 seat bolster
21 cross bar
A first rotation axis
B second rotation axis
X longitudinal direction
Y transverse direction
Z vertical direction

1. A vehicle seat (1), comprising a vehicle seat substructure (2) having a lower portion (3) and an upper portion (4) that is height-adjustable relative thereto, and a seat assembly (5) fastened to the upper portion (4),
wherein the seat assembly (5) comprises a seat carrier (6), a seat depth plate (7) for adjusting a seat depth, and a seat inclination plate (8) for adjusting a seat inclination, wherein the seat depth plate (7) is arranged displaceable in a longitudinal direction (X) within the seat carrier (6), and the seat inclination plate (8) is arranged above the seat depth plate (7) so as to be rotatable about a first rotation axis (A) extending in the transverse direction (Y),
characterized in that the vehicle seat (1) comprises a first electric drive unit (9) for adjusting the seat depth, the first electric drive unit (9) being arranged in a vertical direction (Z) between the seat depth plate (7) and the seat inclination plate (8).

2. The vehicle seat (1) according to claim 1,
characterized in that the seat depth plate (7) and the seat inclination plate (8) are arranged at least partially overlapping and form an overlap region (11), wherein the first drive unit (9) is arranged in the overlap region (11) between the seat depth plate (7) and the seat inclination plate (8).

3. The vehicle seat (1) according to claim 1,
characterized in that the vehicle seat (1) comprises a second electric drive unit (10) for adjusting the seat inclination, wherein the second electric drive unit (10) is arranged substantially laterally next to the seat depth plate (7) and between the seat carrier (6) and the seat inclination plate (8).

4. The vehicle seat (1) according to any one of the preceding claims,
characterized in that the vehicle seat (1) comprises a guide device (12) which connects the seat depth plate (7) displaceably to the seat carrier (6), the guide device (12) comprising a sliding-block-in-groove guidance.

5. The vehicle seat (1) according to any one of the preceding claims,
characterized in that the first electric drive unit (9) comprises a first electric motor (9a), a first spindle (9b) operatively connected thereto, and a first travelling nut (9c) arranged on the first spindle (9b), wherein the first drive unit (9) is fastened to the seat depth plate (7) and the first travelling nut (9c) is received in a rotation-secured manner in a first receiving element (13) which is fastened to the seat carrier (6).

6. The vehicle seat (1) according to any one of the preceding claims,
characterized in that the seat inclination plate (8) is connected to the seat depth plate (7) so as to be rotatable about the rotation axis (A) by a floating bearing (15), the floating bearing (15) being formed by a pin connected to the seat depth plate (7) and a hole-like opening in the seat depth plate (7).

7. The vehicle seat (1) according to claim 3,
characterized in that the second electric drive unit (10) comprises a second electric motor (10a), a second spindle (10b) operatively connected thereto, and a second travelling nut (10c) arranged on the second spindle (10b), wherein the second drive unit (10) is fastened to the seat depth plate (7) and the second travelling nut (10c) is received in a rotation-secured manner in a second receiving element (14), wherein the second receiving element (14) is lever-like and is connected to the seat depth plate (7) so as to be rotatable about a second rotation axis (B), wherein a first lever arm (14a) receives the second travelling nut (10c) and a second lever arm (14b) is connected to the seat inclination plate (8).

8. The vehicle seat (1) according to any one of the preceding claims,
characterized in that the seat depth plate (7) and the seat inclination plate (8), together with the first drive unit (9) and the second drive unit (10), are configured as a seat subassembly (16) insertable as a unit into the seat carrier (6), wherein the seat subassembly (16) comprises a seat cushion (17), and wherein at least the seat inclination plate (8) is arranged between the drive units (9, 10) and the seat cushion (17).

9. The vehicle seat (1) according to claims 5 and 7,
characterized in that the first electric motor (9a) and the second electric motor (10a) extend substantially along the transverse direction (Y) and the first spindle (9b) and the second spindle (10b) extend substantially along the longitudinal direction (X).

10. A vehicle seat (1), comprising a seat assembly (5) with an at least partially shell-shaped seat carrier (6), a seat depth plate (7) for adjusting a seat depth, and a seat inclination plate (8) for adjusting a seat inclination, wherein the seat depth plate (7) is arranged displaceable in a longitudinal direction (X) within the seat carrier (6) and the seat inclination plate (8) is arranged above the seat depth plate (7) so as to be rotatable about a first rotation axis (A) extending in the transverse direction (Y), characterized in that the vehicle seat (1) comprises a first electric drive unit (9) for adjusting the seat depth, the first electric drive unit (9) being arranged in a vertical direction (Z) between the seat depth plate (7) and the seat inclination plate (8).
